(19) United States
(12) Patent Application Publication
(10) Pub. No.: US 2017/0152129 A1
(43) Pub. Date: Jun. 1, 2017

(54) LIVE-WORKING ROBOT

(71) Applicants: State Grid Chongqing Electric Power Co. Electric Power Research Institute, Chongqing (CN); State Grid Corporation of China, Beijing City (CN); The Smartech Institute, Guangdong (CN)

(72) Inventors: Li Tan, Chongqing (CN); Wei Song, Chongqing (CN); Xingzhe Hou, Chongqing (CN); Gaolin Wu, Chongqing (CN); Lei Xia, Chongqing (CN); Xian Meng, Chongqing (CN); Hong Xiang, Chongqing (CN); Ke Li, Chongqing (CN); Guangming Wang, Chongqing (CN); Zhiqing Wu, Chongqing (CN); Weiren Shi, Guangdong (CN); Jianfeng Gan, Guangdong (CN); Chengjiang Wang, Guangdong (CN); Dahong Wang, Guangdong (CN); Ri Lin, Guangdong (CN)

(21) Appl. No.: 15/360,857

(22) Filed: Nov. 23, 2016

(30) Foreign Application Priority Data
Nov. 30, 2015 (CN) 201510862783.9

(51) Int. Cl. B66F 11/04

(52) U.S. Cl. CPC B66F 11/046

(57) ABSTRACT

The present invention discloses a live-working robot, comprising: a telescopic arm and a working hopper, wherein the working hopper and the telescopic arm are slidably connected along a vertical direction and the telescopic arm is provided with the drive component for driving the working hopper to reciprocate along a vertical direction. The live-working robot provided in the present invention achieves a movement of the working hopper along the vertical direction by slidably connecting the working hopper and the telescopic arm along the vertical direction and providing the telescopic arm with the drive component for driving the working hopper to reciprocate along the vertical direction. Since the working hopper is directly and slidably connected with the telescopic arm, there is no need to set a fly jib, which, as compared to the prior art, effectively improves the rigidity and stability of the working arm; which also effectively reduces the length of the working arm, thus reducing the size of the entire live-working robot and reducing the occupied space; and which can meanwhile increase strokes of the working hopper in the vertical direction and thus improve service performance.

### TECHNICAL FIELD

The present invention relates to the technical field of live working, and more particularly to a live-working robot.

### BACKGROUND ART

With economic development and improvement of quality of life, there are continuous requirements for the reliability of the continuous power supply and there is a need for achievement of uninterrupted power transmission throughout the distribution network. In the distribution network, electrical equipment in the long run requires frequent testing, inspection and maintenance. Live working is an effective measure to avoid maintenance at outage and to ensure the normal power supply.

In particular, live working is an operation method for performing maintenance and testing without outage on high-voltage electrical equipment. Live working contents can be divided into several aspects of live testing, live inspection, and live maintenance. Live working is performed on objects including overhead transmission lines, distribution lines, and distribution equipment, etc.

Live working is dangerous and labor intensive, and there are certain difficulties and limitations in manual live working. Therefore, research and development of a live-working robot is of great significance to the long-term development of the power industry. Currently, a working hopper of the live-working robot is connected with a telescopic arm through a fly jib to enable the working hopper to move up and down in a vertical direction. Specifically, one end of the fly jib is connected with the working hopper in a fixed manner and the other end thereof is articulated with the telescopic arm, and the movement of the working hopper in the vertical direction is achieved through rotation of the fly jib in a vertical plane.

However, articulation of the fly jib with the telescopic arm results in poor rigidity and poor stability of the entire working aim.

In addition, the setting of the fly jib causes that the entire live-working robot has a large volume and occupies a large space.

Further, the fly jib has such a small angle of rotation in the vertical plane that the working hopper has small strokes in the vertical direction.

In summary, how to provide a live-working robot in order to improve the rigidity and stability of its working arm is currently a problem to be solved by those skilled in the art.

### SUMMARY OF THE INVENTION

The object of the present invention is to provide a live-working robot in order to improve the rigidity and stability of its working arm.

To achieve the above object, the present invention provides the following technical solutions:

A live-working robot, comprising: a telescopic arm and a working hopper, wherein said working hopper and said telescopic arm are slidably connected along a vertical direction and said telescopic arm is provided with a drive component for driving said working hopper to reciprocate along a vertical direction.

Preferably, an end of said telescopic arm is provided with a slider, and a side plate connecting said working hopper with said telescopic arm is provided with a slide rail matching with the slider.

Preferably, the above live-working robot further comprises: a mounting plate perpendicularly connected to said slide rail, said mounting plate being located at a bottom of said slide rail and said mounting plate being fixed to a bottom of said working hopper.

Preferably, said drive component is a hydraulic cylinder.

Preferably, said telescopic arm is an insulating arm and said working hopper is an insulating hopper.

Preferably, materials of said working hopper and said telescopic arm are both glass fiber reinforced plastics.

Preferably, said glass fiber reinforced plastics have a density of 1.15˜1.73 kg/m³, a tensile strength of 290.77˜350.2 MPa, a bending strength of 330.06˜495 MPa, a compressive strength of 216.58˜367.2 MPa, a parallel layer breakdown voltage of greater than or equal to 15 KV, and a dielectric constant of 4.7˜5.2.

Preferably, said live-working robot has a rotating table power source and a chassis power source which are both batteries.

Preferably, said live-working robot has a chassis comprising: an underframe, a steering wheel provided at a front end of said underframe, a drive wheel provided at a rear end of said underframe, a front leveling mechanism and a rear leveling mechanism which can both be telescopic along a vertical direction, wherein said front leveling mechanism is fixed to the front end of said underframe and said rear leveling mechanism is provided at the rear end of said underframe.

Preferably, the number of said front leveling mechanism and said rear leveling mechanism is two, respectively.

Said front leveling mechanism comprises: front leveling feet, a front drive component being connected to said front leveling feet and driving said front leveling feet to reciprocate along a vertical direction, and a front support plate fixed to said underframe, wherein said front drive component is fixed to said front support plate, said front leveling feet is located at a front end of said steering wheel, and an end of said front support plate connected to said underframe is located between said underframe and said steering wheel.

Said rear leveling mechanism comprises: rear leveling feet, a rear drive component being connected to said rear leveling feet and driving said rear leveling feet to reciprocate along a vertical direction, and a rear support plate fixed to said underframe, wherein said rear drive component is fixed to said rear support plate, said rear leveling feet is located at a rear end of said drive wheel, and an end of said rear support plate connected to said underframe is located between said underframe and said drive wheel.

The live-working robot provided in the present invention achieves a movement of the working hopper along the vertical direction by slidably connecting the working hopper and the telescopic arm along the vertical direction and providing the telescopic arm with the drive component for driving the working hopper to reciprocate along the vertical direction. Since the working hopper is directly and slidably connected with the telescopic arm, there is no need to set the fly jib, which, as compared to the prior art, effectively improves the rigidity and stability of the working arm.

Meanwhile, the live-working robot provided in the present invention has the working hopper directly and slidably connected with the telescopic arm, so there is no need to set the fly jib, which effectively reduces the length of the working arm, thus reducing the size of the entire live-working robot and reducing the occupied space.

Meanwhile, the live-working robot provided in the present invention has the working hopper directly and slidably connected with the telescopic arm, which can increase strokes of the working hopper in the vertical direction and thus improve service performance.

### BRIEF DESCRIPTION OF DRAWINGS

In order to more clearly illustrate the examples of the present invention or the technical solutions in the prior, a simple introduction will be made below to the drawings necessary for description of the examples or the prior art. It is obvious that the drawings in the following description are only the examples of the present invention and those of ordinary skill in the art can also obtain, without creative work, other drawings according to the drawings provided.

FIG. 1 is a schematic diagram of the structure of the live-working robot provided in the examples of the present invention.

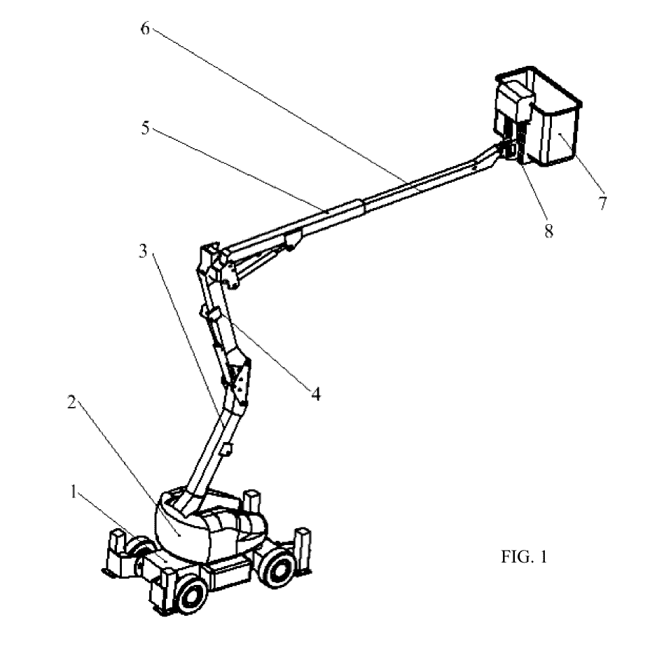

In FIG. 1:

1 is a chassis, 2 is a rotating table, 3 is a lower folding arm, 4 is an upper folding arm, 5 is a basic arm, 6 is a telescopic arm, 7 is a working hopper, and 8 is a slide rail.

### DETAILED DESCRIPTION OF EMBODIMENTS

The technical solutions of the present invention will be clearly and fully described below in combination with the drawings in the examples of the present invention. It is obvious that the described examples are merely one part but not all of the examples of the present invention. All other examples obtained by those of ordinary skill based on the examples of the present invention without creative work fall within the protection scope of the present invention.

At present, the live-working robot mainly comprises: a chassis 1, a rotating table 2 provided on the chassis 1, an upper installation 3 provided on the rotating table 2, a working hopper 7 connected with the upper installation 3, wherein the upper installation 3 comprises a working arm including: a lower folding arm 3 connected with the rotating table 2, an upper folding arm 4 connected with the lower folding arm 3, a basic arm 5 connected with the upper folding arm 4, and a telescopic arm 6 with its one end connected with the basic arm 5 and the other end connected with the working hopper 7.

The live-working robot provided in the examples of the present invention comprises: a telescopic arm 6 and a working hopper 7, wherein the working hopper 7 and the telescopic arm 6 are slidably connected along the vertical direction and the telescopic arm 6 is provided with a drive component for driving the working hopper 7 to reciprocate along the vertical direction.

The live-working robot provided in the examples of the present invention achieves a movement of the working hopper 7 along the vertical direction by slidably connecting the working hopper 7 and the telescopic arm 6 along the vertical direction and providing the telescopic arm 6 with the drive component for driving the working hopper 7 to reciprocate along the vertical direction. Since the working hopper 7 is directly and slidably connected with the telescopic arm 6, there is no need to set the fly jib, which, as compared to the prior art, effectively improves the rigidity and stability of the working arm.

Meanwhile, the live-working robot provided in the examples of the present invention has the working hopper 7 directly and slidably connected with the telescopic arm 6, so there is no need to set the fly jib, which effectively reduces the length of the working arm, thus reducing the size of the entire live-working robot and reducing the occupied space.

Meanwhile, the live-working robot provided in the examples of the present invention has the working hopper 7 directly and slidably connected with the telescopic arm 6, which can increase strokes of the working hopper 7 in the vertical direction and thus improve service performance.

In order to facilitate the movement of the working hopper 7 along the vertical direction, that an end of the telescopic arm 6 is provided with a slider and a side plate connecting the working hopper 7 with the telescopic arm 6 is provided with a slide rail 8 matching with the slider is a preferable choice. In this way, the matching of the slide rail 8 with the slider ensures the direction of movement of the working hopper 7 and avoids shifting of the working hopper 7 during the process of movement.

Preferably, the above live-working robot further comprises: a mounting plate perpendicularly connected to the slide rail 8, the mounting plate being located at a bottom of the slide rail 8 and the mounting plate being fixed to a bottom of the working hopper 7.

The above drive component can be a hydraulic cylinder, a gas cylinder, a linear motor, etc. To facilitate the setting, the drive component is a hydraulic cylinder is a preferable choice.

In the above live-working robot, the chassis 1 is of two-wheel drive and two-wheel steering (standard configuration). The chassis has a maximum traveling speed of 7 km/h, a maximum climbable gradient of 20%, at which gradient the machine can stop without skidding and can start again and walk. The chassis 1 is of two-wheel brake (standard configuration), the drive tires of the chassis 1 release the spring using standard automatic hydraulic pressure to perform braking and enable the aerial work platform (the working hopper 7) to stop at the climbable gradient of 20% without skidding.

In particular, the above chassis 1 comprises: an underframe, a steering wheel provided at a front end of said underframe, and a drive wheel provided at a rear end of said underframe. In order to enable the chassis 1 to be adapted to various conditions on the ground and to ensure normal operation of the working hopper 7, the chassis 1 further comprises: a front leveling mechanism and a rear leveling mechanism which can both be telescopic along a vertical direction, wherein the front leveling mechanism is fixed to the front end of the underframe and the rear leveling mechanism is provided at the rear end of the underframe.

In order to improve the leveling effect, there are two front leveling mechanisms and two rear leveling mechanism as described above, the two front leveling mechanisms are symmetrical with respect to a central line of symmetry of two steering wheels, and the two rear leveling mechanisms are symmetrical with respect to a central line of symmetry of two drive wheels. Of course, the number of the front leveling mechanism and the rear leveling mechanism can both be selected from one, three, or the like; or can be different, and such selection is not limited to the examples described above.

In the above chassis 1, the front leveling mechanism and the rear leveling mechanism have a plurality of structures; for example, they both include a lead screw structure, a screw of the lead screw structure is driven by a motor to rotate and the screw of the lead screw structure is fixed along its axial direction, the lead screw is connected to the underframe, and the axial direction of the lead screw is a vertical direction. In this way, as the motor drives the screw to rotate, the lead screw moves along the vertical direction to achieve leveling. Of course, other structures can also be chosen.

In order to reduce costs, preferably, the front leveling mechanism comprises: front leveling feet, a front drive component being connected to the front leveling feet and driving the front leveling feet to reciprocate along a vertical direction, and a front support plate fixed to said underframe, wherein the front drive component is fixed to the front support plate. Correspondingly, the rear leveling mechanism comprises: rear leveling feet, a rear drive component being connected to the rear leveling feet and driving the rear leveling feet to reciprocate along a vertical direction, and a rear support plate fixed to the underframe, wherein the rear drive component is fixed to the rear support plate.

In order to effectively reduce the occupied area, preferably, the front leveling feet is located at a front end of the steering wheel and an end of the front support plate connected to the underframe is located between the underframe and the steering wheel. The rear leveling feet is located at a rear end of the drive wheel and an end of the rear support plate connected to the underframe is located between the underframe and the drive wheel. In this way, the width of the entire chassis 1 can be effectively reduced, thereby reducing the occupied area.

Preferably, the front drive component and the rear drive component are both hydraulic cylinders. Of course, other drive components, such as gas cylinders and linear motors can also be chosen as the front drive component and the rear drive component. This is not limited in the examples of the present invention.

In order to simplify the structure, preferably, an underframe driving component for driving the underframe to move is a linear motor and the linear motor is connected to the drive wheel via a retarding mechanism. To reduce costs, the chassis power source of the chassis 1 is a battery which provides power to ensure movement of the chassis 1. Furthermore, a battery system 5 is a lead-acid battery system. In practical application process, the number of the battery can be selected as needed, for example, 8 groups of 6V lead-acid batteries can be selected as the battery system 5; and use of foreign high-quality batteries can achieve stable and reliable power supply, fast charging, and long time of endurance (working for 6 h, standby for 8 h).

In the above rotating table 2, 355° swiveling reveals a transport lockpin hole site (in the front and at the back of the drive chassis); a drive unit for the rotating table 2 uses an imported DC motor with original packaging which is powerful and reliable, a table rotating power source for the rotating table 2 is a battery, in particular, 8 groups of 6V batteries with a battery capacity of 420 Ah is employed; in a control system (including a platform control operating handle) of the rotating table 2, a ground controller integrates all the debugging functions and is associated with actions of an arm lever; machine and component calibration is handled via the control system and all valves and controllers (handle) are handled via the control system (including initial setup and debugging); and for system diagnosis of the rotating table 2, the control system can make self-diagnosis of major types of errors occurring in the system and in all components connected to the system, and major malfunctions will be indicated by concentrated instrument flashing lights and alarmed by a buzzer.

The upper installation of the above live-working robot consists of a lower folding arm 3, an upper folding arm 4, a basic arm 5, and a telescopic arm 6, and this structure is simple and flexible and can achieve the actions of moving the working hopper 7 up and down accurately, stably and reliably. Specifically, the upper installation employs a crank arm type arm support design, so it can take actions more flexibly, span a higher height, and apply to a complex working environment; the basic arm support is made from the material of high-strength steel via welding, thus reducing weight and improving safety; the upper installation employs hydraulic servo leveling which is more secure and reliable to avoid the risk of leveling failure due to electrical malfunction.

Preferably, the above telescopic arm 6 is an insulating arm. Furthermore, materials of the telescopic arm 6 are glass fiber reinforced plastics and the glass fiber reinforced plastics are advanced composite insulation materials which have a high strength, a light weight, and a pressure rating of 10 KV. Specifically, the glass fiber reinforced plastics have a density of 1.15˜1.73 kg/m³, a tensile strength of 290.77˜350.2 MPa, a bending strength of 330.06˜495 MPa, a compressive strength of 216.58˜367.2 MPa, a parallel layer breakdown voltage of greater than or equal to 15 KV, and a dielectric constant of 4.7˜5.2.

Preferably, the above working hopper 7 is an insulating hopper. Furthermore, materials of the working hopper 7 are glass fiber reinforced plastics and the glass fiber reinforced plastics are advanced composite insulation materials which have a high strength, a light weight, and a pressure rating of 10 KV. Specifically, the glass fiber reinforced plastics have a density of 1.15˜1.73 kg/m³, a tensile strength of 290.77˜350.2 MPa, a bending strength of 330.06˜495 MPa, a compressive strength of 216.58˜367.2 MPa, a parallel layer breakdown voltage of greater than or equal to 15 KV, and a dielectric constant of 4.7˜5.2.

The above working hopper 7 employs 160° hydraulic platform rotation. The working hopper 7 has a load capacity of up to 200 kg. The working hopper 7 has a vertical lift function with a stroke of 500 mm.

As for platform control of the above working hopper 7, all major functions of driving and steering, lifting and telescoping of the arm lever and swiveling of the rotating table are controlled by the handle. An imported proportional handle is used for control to achieve vehicle traveling; secondary functions of platform leveling and platform rotation are controlled by a toggle switch; and selection functions of motor speed, motor start-up, auxiliary control, enabling during traveling, traveling speed, speaker, etc. are controlled using button switches.

A safety device of the above live-working robot performs full-scale gradient control on driving, lifting of the arm lever, telescoping of the arm lever, and rotation of the chassis such that an operating vehicle even in a narrow environment can find it easy to position and will operate more smoothly. A driving confirmation system of the safety device is used to enhance an operator's alertness and safety. When the arm is turned past the non-steering wheel, an driving action cannot be operated and simultaneously an indicator light on the platform operation panel is turned on, indicating that the driving direction is opposite to the current direction of movement. At this time, a driving recovery function must be used by a driving confirmation switch to ensure that the operator knows the correct location of the arm and the correct direction of driving the handle. A foot switch of the safety device controls all functions. One's foot must leave the foot switch to start a travel motor. All functions on a control panel of the security device are represented by easy and understandable pictographic symbols.

A hydraulic system of the above live-working robot selects to use travel motor and drive pump products from known international companies, is configured with hydraulic filtering and oil return filtering besides a pump and employs full pressure hydraulic filtering, and employs a closed cycle hydraulic driving loop which supplies unsurpassed power and performance. An axial variable piston pump and a piston travel motor at the latest developing level of technology are used for a driving system loop. Hydraulic system modules are employed to improve maintainability and troubleshooting while providing reliability. Hydraulic pressure is incorporated into four hydraulic modules which are useful for the arm lever function, drive function, platform function and auxiliary power function, respectively which increases reliability while reducing the hose, connectors, and possible leakage. Diagnostic installation, troubleshooting, and maintainability improve hydraulic and traditional piping systems.

The previous description on the disclosed examples enables those skilled in the art to achieve or use this invention. Various modifications to these examples will be obvious to those skilled in the art, and the general principles defined herein may be realized in other examples without departing from the spirit or scope of the present invention. Accordingly, the present invention will not be limited to these examples shown herein, but should comply with the widest range consistent with the principles and novel features disclosed herein.

What is claimed is:

1. A live-working robot, comprising: a telescopic arm (6) and a working hopper (7), characterized in that said working hopper (7) and said telescopic arm (6) are slidably connected along a vertical direction and said telescopic arm (6) is provided with a drive component for driving said working hopper (7) to reciprocate along a vertical direction.

2. The live-working robot as recited in claim 1, characterized in that an end of said telescopic arm (6) is provided with a slider, and a side plate connecting said working hopper (7) with said telescopic arm (6) is provided with a slide rail (8) matching with said slider.

3. The live-working robot as recited in claim 2, characterized in that it further comprises: a mounting plate perpendicularly connected to said slide rail (8), said mounting plate being located at a bottom of said slide rail (8) and said mounting plate being fixed to a bottom of said working hopper (7).

4. The live-working robot as recited in claim 1, characterized in that said drive component is a hydraulic cylinder.

5. The live-working robot as recited in claim 1, characterized in that said telescopic arm (6) is an insulating arm and said working hopper (7) is an insulating hopper.

6. An insulating protective structure of the live-working robot as recited in claim 5, characterized in that materials of said working hopper (7) and said telescopic arm (6) are both glass fiber reinforced plastics.

7. The insulating protective structure of the live-working robot as recited in claim 6, characterized in that said glass fiber reinforced plastics have a density of 1.15˜1.73 kg/m³, a tensile strength of 290.77˜350.2 MPa, a bending strength of 330.06˜495 MPa, a compressive strength of 216.58˜367.2 MPa, a parallel layer breakdown voltage of greater than or equal to 15 KV, and a dielectric constant of 4.7˜5.2.

8. The live-working robot as recited in claim 1, characterized in that said live-working robot has a rotating table power source and a chassis power source which are both batteries.

9. The live-working robot as recited in claim 1, characterized in that said live-working robot has a chassis (1) comprising: an underframe, a steering wheel provided at a front end of said underframe, a drive wheel provided at a rear end of said underframe, a front leveling mechanism and a rear leveling mechanism which can both be telescopic along a vertical direction, wherein said front leveling mechanism is fixed to the front end of said underframe and said rear leveling mechanism is provided at the rear end of said underframe.

10. The live-working robot as recited in claim 9, wherein the number of said front leveling mechanism and said rear leveling mechanism is two, respectively;
Said front leveling mechanism comprises: a front leveling feet, a front drive component being connected to said front leveling feet and driving said front leveling feet to reciprocate along a vertical direction, and a front support plate fixed to said underframe, wherein said front drive component is fixed to said front support plate, said front leveling feet is located at a front end of said steering wheel, and an end of said front support plate connected to said underframe is located between said underframe and said steering wheel;
Said rear leveling mechanism comprises: a rear leveling feet, a rear drive component being connected to said rear leveling feet and driving said rear leveling feet to reciprocate along a vertical direction, and a rear support plate fixed to said underframe, wherein said rear drive component is fixed to said rear support plate, said rear leveling feet is located at a rear end of said drive wheel, and an end of said rear support plate connected to said underframe is located between said underframe and said drive wheel.
